(19) United States
(12) Patent Application Publication
(10) Pub. No.: US 2017/0262784 A1
(43) Pub. Date: Sep. 14, 2017

(54) APPARATUS, METHOD, AND COMPUTER PROGRAM PRODUCT FOR CORRELATING GLOBAL POSITIONING SYSTEM DATA AND ISO 8583 NETWORK TRANSACTION DATA OR THE LIKE

(71) Applicant: MasterCard International Incorporated, Purchase, NY (US)

(72) Inventors: Patrick Lowery, New York, NY (US); Mary Ellen Kelleher, Stamford, CT (US); Nikhil Ledlie, New York, NY (US)

(21) Appl. No.: 15/065,616

(22) Filed: Mar. 9, 2016

(51) Int. Cl. G06Q 10/06; G06Q 50/12; G06Q 30/02

(52) U.S. Cl. CPC G06Q 10/063114; G06Q 30/0201; G06Q 30/0267; G06Q 50/12; G06Q 10/06313

(57) ABSTRACT

A mobile application is made available for download to a device associated with a mobile business. Data describing a varying location of the business (and including an ID) is obtained by exposing an API to the application over a wireless network. The varying location is tracked by the application interfacing with a GPS unit of the device. A database of payment card transactions is queried based on the ID to obtain payment card transaction data (amount and time stamp) for a plurality of transactions at the mobile business. A location is assigned to each of the transactions, based on matching the time stamps of each of the transactions with a corresponding location in the data, to obtain augmented transaction data; and an alert is sent to the mobile application based on the augmented transaction data.

### FIELD OF THE DISCLOSURE

The present disclosure relates generally to the electronic and computer arts, and, more particularly, to network technology and analytics and the like.

### BACKGROUND OF THE DISCLOSURE

The use of payment cards, such as credit cards, debit cards, and pre-paid cards, has become ubiquitous. Most payment card accounts have one or more associated physical cards; however, the use of non-traditional payment devices, such as appropriately-configured “smart” cellular telephones, is increasing. A wealth of transaction data is available from payment card usage.

Many modern “smart” cellular telephones or similar devices, regardless of whether they are used as payment devices, include global positioning system (GPS) capability (or perhaps similar capability; non-limiting examples of GPS-like capability include the European GALILEO system or Russian GLONASS system). Many modern motor vehicles also include GPS type functionality.

### SUMMARY OF THE DISCLOSURE

Principles of the present disclosure provide techniques for correlating global positioning system data and ISO 8583 network transaction data or the like. In one aspect, an exemplary method includes making a mobile application available for download to a mobile device associated with a mobile business; obtaining, from the mobile business, data describing a varying location of the mobile business over a time period of interest, by exposing an application programming interface to the mobile application over a wireless network. The data also includes an identifying indicia of the mobile business, and the varying location of the mobile business over the time period of interest is tracked by the mobile application interfacing with a global positioning system unit of the mobile device associated with the mobile business. A further step includes querying a database of payment card transactions based on the identifying indicia of the mobile business to obtain payment card transaction data for a plurality of transactions at the mobile business during the time of interest. The payment card transaction data includes, for each of the transactions, amount and time stamp. Yet further steps include assigning, to each of the transactions, a location, based on matching the time stamps of each of the transactions with a corresponding location in the data describing the varying location of the mobile business over the time period of interest, to obtain augmented transaction data; and sending an alert to the mobile application based on the augmented transaction data.

In another aspect, another exemplary method includes making browser-executable code available to a browser of a mobile device associated with a mobile business; obtaining, from the mobile business, data describing a varying location of the mobile business over a time period of interest, by client-server communication over a wireless network. The data also includes an identifying indicia of the mobile business. The varying location of the mobile business over the time period of interest is tracked by the browser-executable code interfacing with a global positioning system unit of the mobile device associated with the mobile business. A further step includes querying a database of payment card transactions based on the identifying indicia of the mobile business to obtain payment card transaction data for a plurality of transactions at the mobile business during the time of interest. The payment card transaction data includes, for each of the transactions, amount and time stamp. Even further steps include assigning, to each of the transactions, a location, based on matching the time stamps of each of the transactions with a corresponding location in the data describing the varying location of the mobile business over the time period of interest, to obtain augmented transaction data; and sending an alert to the browser of the mobile device based on the augmented transaction data.

Aspects of the disclosure contemplate the method(s) described herein performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the disclosure or elements thereof can be implemented in the form of a computer program product including a tangible computer readable recordable storage medium with computer usable program code for performing the method steps indicated stored thereon in a non-transitory manner. Furthermore, one or more embodiments of the disclosure or elements thereof can be implemented in the form of a system (or apparatus) including a memory and at least one processor that is coupled to the memory and operative to perform exemplary method steps. Yet further, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the disclosure can provide substantial beneficial technical effects, as will be appreciated by the skilled artisan from the discussion herein. For example, one or more embodiments provide an architecture which enhances processing speed, wherein real-time data from a truck owner or other mobile business is parallel processed within a Hadoop server environment using Impala, a SQL based language that is run in memory to process information faster. These and other features and advantages of the present disclosure will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the disclosure;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, useful in connection with one or more embodiments of the disclosure;

FIGS. 3 and 4 provide an exemplary detailed view of operation of an exemplary payment card network, in accordance with an aspect of the disclosure;

FIG. 5 shows a group of payment network interface processors, such as may be used with the network of FIGS. 3 and 4;

FIG. 6 shows a port arrangement on a payment network interface processor, such as may be used with the network of FIGS. 3 and 4;

FIG. 7 shows an illustrative case wherein an issuer has multiple payment network interface processors;

FIG. 8 is a block diagram of a “smart” phone or tablet computer useful in one or more embodiments of the disclosure;

FIG. 9 is a block diagram of an exemplary computer system useful in one or more embodiments of the disclosure;

FIG. 10 shows an exemplary system block diagram, in accordance with an aspect of the disclosure;

FIG. 11 is a flow chart of an exemplary method, in accordance with an aspect of the disclosure;

FIG. 12 shows exemplary latitude, longitude, and time data for a mobile business, gathered in accordance with an aspect of the disclosure;

FIG. 13 shows exemplary payment card transaction data corresponding to the mobile business data of FIG. 12;

FIGS. 14-16 are simulated screen shots of business insights presented on a mobile device of a mobile business, in accordance with an aspect of the disclosure; and

FIG. 17 shows initiation of a targeted offer from a mobile device of a mobile business, in accordance with an aspect of the disclosure.

### DETAILED DESCRIPTION OF PREFERRED EMBODIMENTS

### Payment Devices and Associated Payment Processing Networks

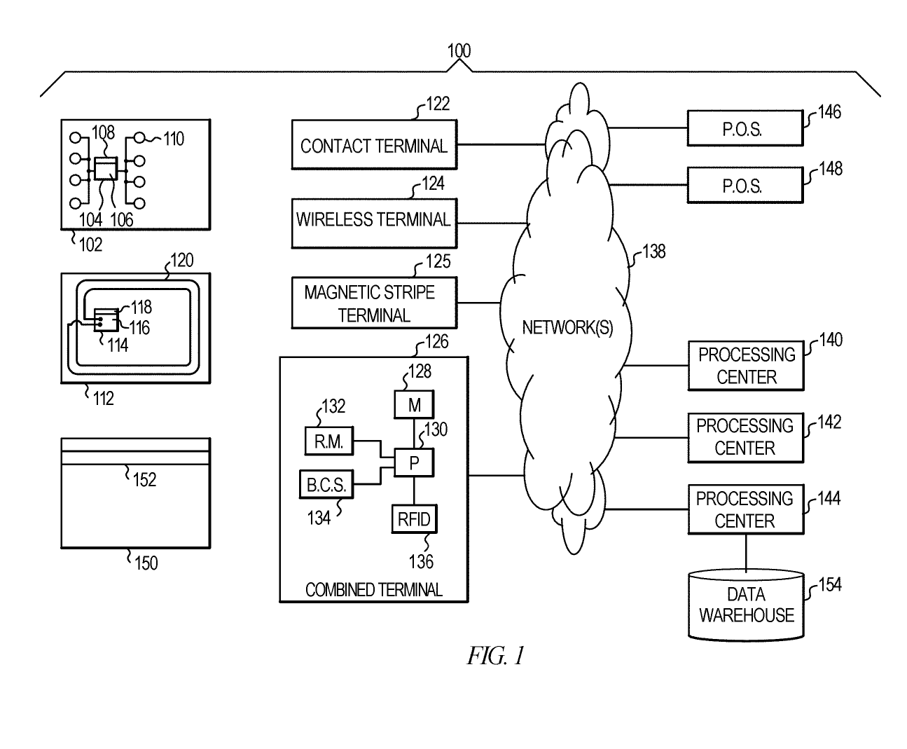

With regard to payment card and similar payments, attention should now be given to FIG. 1, which depicts an exemplary embodiment of a system 100, according to an aspect of the disclosure, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional magnetic stripe device 150, such as a card having a magnetic stripe 152. Furthermore, an appropriately configured mobile device (e.g., “smart” cellular telephone handset, tablet, personal digital assistant (PDA), and the like) can be used to carry out contactless payments in some instances; for example, via near field communications (NFC), wherein the appropriately configured mobile device acts like a contactless card 112 (or, with an electronic wallet present, like multiple such cards).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present disclosure is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (marks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

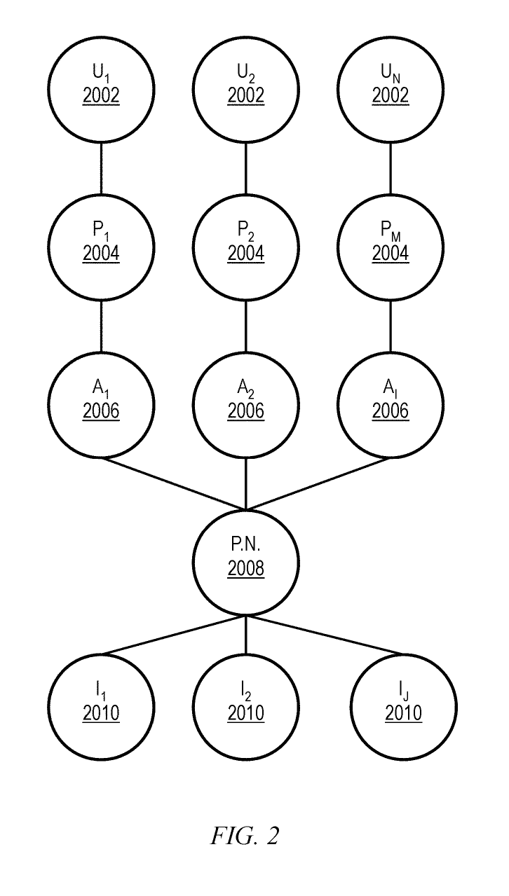

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone, tablet, or the like.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 150. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

The system depicted in FIG. 1 may in general involve not only conventional transactions at “brick and mortar” merchants, but also card-not-present transactions, such as card-not-present Internet transactions or card-not-present recurring payments. In some instances, an Internet Protocol (IP) address may be captured during card-not-present Internet transactions. In exemplary card-not-present Internet transactions, an individual utilizes his or her home computer to communicate with a server of an e-commerce merchant over the Internet. The individual provides his or her PAN to the merchant's server. The merchant utilizes the PAN to initiate an authorization request, and upon receiving an authorization request response indicating approval, will complete the e-commerce transaction. In exemplary card-not-present recurring payments, an individual provides his or her PAN and related data to a merchant (e.g., via phone or postal mail). The merchant utilizes the PAN to initiate an authorization request, and upon receiving an authorization request response indicating approval, will complete the recurring transaction.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions. In this regard, a “cardholder” should be understood to refer to the account holder of a payment card account, regardless of whether the holder actually has a physical payment card or other physical payment device.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . Iⱼ, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal. Note, also, that elements 2006, 2010 represent the entities that actually carry out processing for the acquirers and issuers respectively; in some instances, these entities carry out their own processing; in other entities, they utilize acquirer processors and issuer processors, respectively.

During a conventional credit authorization process, the cardholder 2002 pays for the purchase and the merchant 2004 submits the transaction to the acquirer (acquiring bank) 2006. The acquirer verifies the card number, the transaction type, and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. Some embodiments of the disclosure may be employed in relation to payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the International Organization for Standardization (ISO) Standard 8583, Financial transaction card originated messages Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of payment card transactions such as for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing or procurement card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN) (which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. No. 6,636,833 (expressly incorporated herein by reference in its entirety for all purposes) and U.S. Pat. No. 7,136,835 (expressly incorporated herein by reference in its entirety for all purposes) of Flitcroft et al.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network. Other non-limiting examples of payment card networks include the AMERICAN EXPRESS® and DISCOVER® networks.

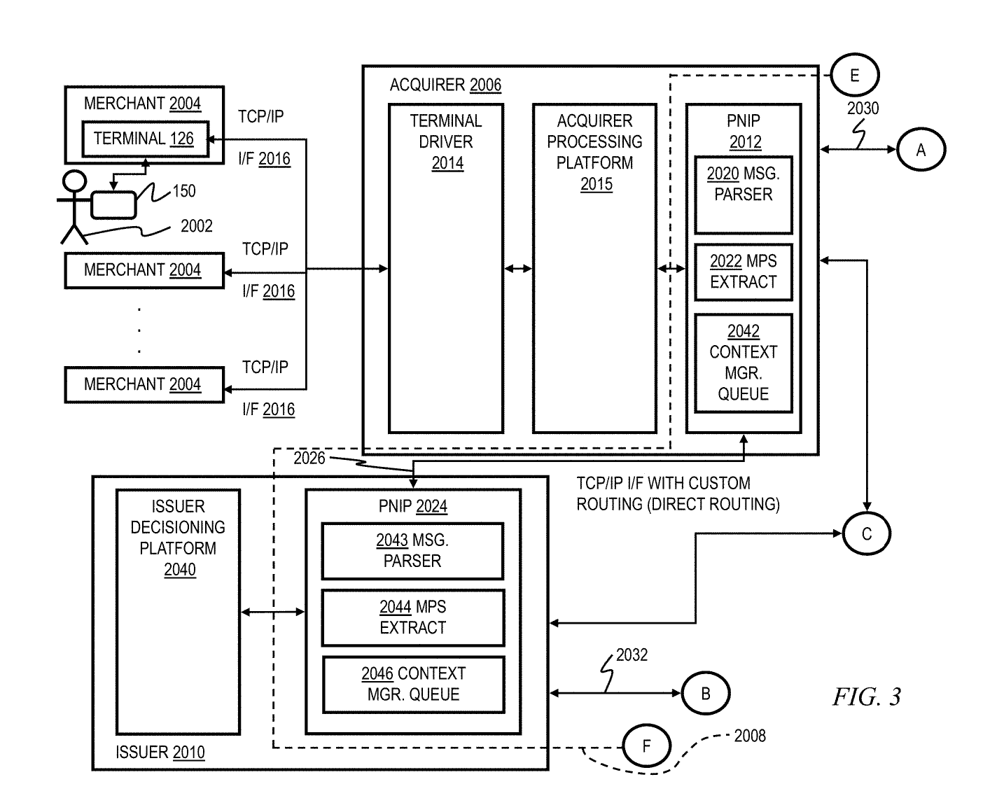

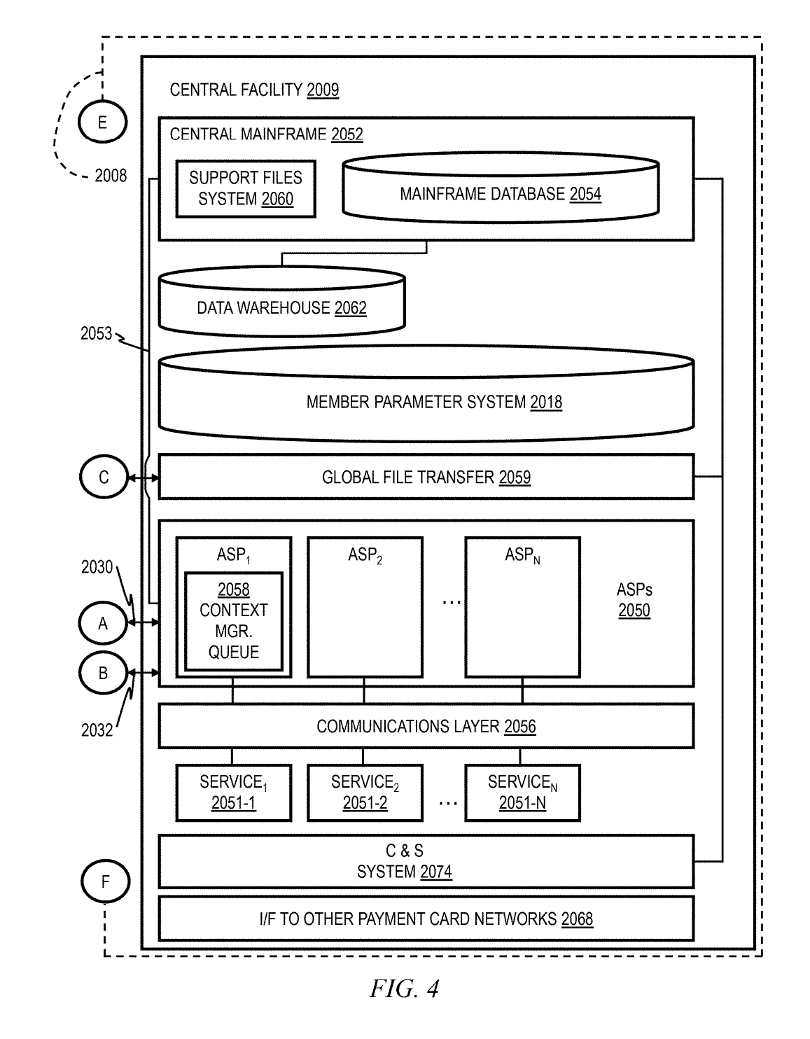

Still referring to FIG. 2, and with reference also now to FIGS. 3 and 4, by way of review and provision of additional detail, a consumer 2002 effectively presents his or her card 150 or other payment device (e.g., presents suitably configured “smart” phone or uses an e-wallet) to the terminal 126 of a merchant 2004. A mag stripe card 150 and combined terminal 126 are shown by way of example, but are intended to generally represent any kind of payment device and any kind of terminal. The effective presentation can happen directly (user enters a brick and mortar location of a merchant 2004) or virtually (user logs on to a web site of a merchant 2004 via a browser of a personal computer or the like, or calls on the telephone, and provides card information, or sends a “snail” mail with payment card account information to a merchant). The merchant terminal 126 captures the card account information (by swiping or wireless communication if directly presented; by manual keying or reading data if remote) and forwards same to the acquirer 2006. Interaction between the merchant and cardholder is outside the purview of the payment card network per se. The payment card network becomes involved at the connection between the acquirer 2006 and network 2008; the dotted line between points E and F in FIGS. 3 and 4 encompasses the network 2008. Note generally that points A, B, C, E, and F in FIG. 3 connect to the corresponding points in FIG. 4; the entire network and associated environment are not amenable to illustration on a single sheet.

The acquirer 2006, in the specific example of FIGS. 3 and 4, has at its premises a payment network interface processor (PNIP 2012). The MasterCard Interface Processor or MIP is a non-limiting example of a PNIP. In a non-limiting example, the PNIP is implemented on a rack-mounted server. PNIPs are typically located at the edges of the payment card network. In at least some instances, the payment card network of FIG. 2 is a distributed network wherein each acquirer and issuer has at least one PNIP on their premises. Each acquirer 2006 will have a relationship with one or more merchants 2004 and will interface with the merchants' terminals 126 via terminal driver 2014 (an acquirer may also act as an acquirer for themselves as a merchant). Furthermore in this regard, the merchant locations will have terminals where the cards are swiped (or where contacted or contactless devices are presented). The acquirer will employ terminal driver 2014 to interface with those terminals. Terminal driver 2014 is a logical block representing software and/or hardware that allows the acquirer processing platform 2015 to communicate with the terminals of the merchants via TCP, dial up, or the like (TCP/IP interfaces 2016 are shown in the example in the figures). Each merchant will decide what acquirer to use to accept one or more brands of payment cards, and the acquirer will set the merchant up with the appropriate software and/or firmware for the merchant's point of sale devices.

The acquirer 2006 will present transactions from many different merchants 2004 to the payment card network operator 2008 via the PNIP interface 2012. The connection between the merchants 2004 and the acquirer 2006 is typically a TCP/IP interface 2016. The format that the transaction is in when the card is swiped at the merchant 2004 may differ from the format that the transaction is in when actually received by the payment card network operator. The acquirer may convert the transaction into the ISO 8583 format or into a format that is a specific implementation of the ISO 8583 format (e.g., the MASTERCARD CIS (customer interface specification) format. The authorization request message can be an ISO 8583 message type identifier (MTI) 0100 message, for example, sent over the communications interface 2016 between the merchant 2004 and the acquirer 2006.

Once the 0100 message is received at the PNIP 2012 of the acquirer 2006, a series of edits can be performed on the transaction with respect to format, content, and/or context. Furthermore, screening can be carried out to determine whether the message relates to something beyond an ordinary authorization request, referred to as an enhanced service. Enhanced services may be screened for on behalf of one or more issuers 2010 and/or the operator of network 2008 itself. A centralized member parameter system (MPS) 2018 can be provided to house parameters used to drive processing of credit authorization transactions. In one or more embodiments, extracts from the centralized member parameter system 2018 are distributed to all acquirer PNIPs 2012 and issuer PNIPs 2024 on the network 2008 on a daily basis to drive processing of credit card transactions.

It should be noted at this point that an “ICA” and a “BIN” are employed in BANKNET so that a member can perform card issuing and/or acquiring activities. An ICA or Interbank Card Association is a four to six digit identification assigned by MasterCard for use by a member to uniquely identify activity the member is responsible for. A BIN or Bank Identification Number is a unique series of numbers assigned by MasterCard to a principal member and used as the first six digits of a cardholder account number. Other payment card networks have similar types of numbers, as will be apparent to the skilled artisan.

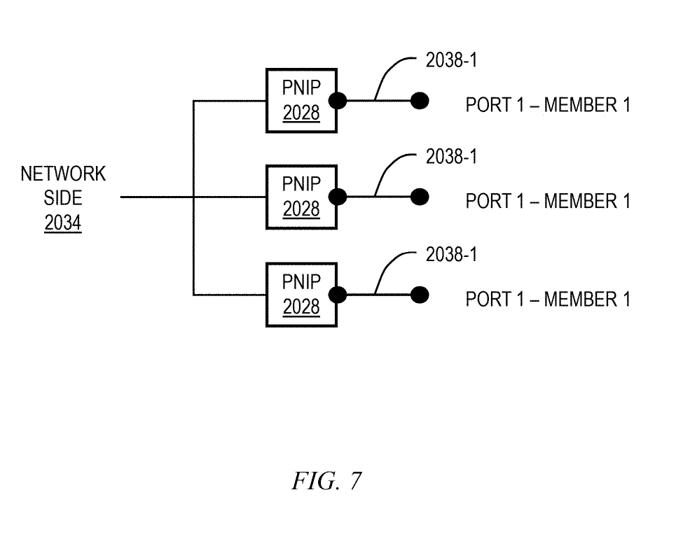

In at least some embodiments, the same member parameter extract is sent to all PNIPs and transactions are routed using same. In at least some circumstances, account numbers or ranges of account numbers are used in deciding how to route. In some cases, transactions are routed to an issuer PNIP based on where the account range is “signed in.” Issuers send an MTI 0800 sign in request message with either a group ID or account range. The Member ID is pulled from the PNIP port 2038 configuration and transactions from that account range are then routed to the port from which the sign-in request is received. A member ID can be present on ports on multiple PNIPs at an Issuer site—see discussion of FIGS. 6 and 7 below.

In one or more embodiments, based on the account range, the parameters in MPS 2018 (or a local extract thereof) will determine how to process a given transaction; e.g., product code, country code, currency code, and the like, including what enhanced services (if any) the issuer has signed up for on a particular account range. That is to say, the messages are parsed and certain fields, including the account range, are examined; the account range is associated with a certain issuer and based on that, the message may be treated differently. Messages may be parsed, and converted into an internal data format so that access can be obtained to all the individual data elements. In one or more embodiments, the account number is used as a key to access the MPS 2018 (or a local extract thereof) and retrieve all the parameters that are appropriate for processing the given transaction. In a non-limiting example, a suitable message parser 2020 (and other programs on the PNIP 2012) can be written in an appropriate high-level language or the like.

In an exemplary embodiment, the central MPS 2018 creates extracts once a day that are distributed out to the endpoints on the network (e.g., PNIPs 2012), as seen at 2022. These extracts include the pertinent information needed for the PNIP to process the message and determine if it requires any special handling. In some instances, messages are next routed to a central site 2009 for performance of enhanced services. On the other hand, if no special services are required, the message may be routed directly to the issuer PNIP 2024 as seen at 2026.

Messages Routed Directly to the Issuer PNIP:

In this aspect, the transaction is routed directly to the issuer PNIP 2024 based on the MPS extract 2022, as seen at 2026. Every account range will have a unique destination endpoint identified in the parameters (account ranges may be grouped and all members of the account range group may have a common destination endpoint). The member interface refers to the connection between the acquirer processor 2006 and the Acquirer PNIP 2012. This term also applies to the interface between the Issuer PNIP 2024 and issuer processor 2010. The connections between and among acquirer PNIP 2012 and issuer PNIP 2024, acquirer PNIP 2012 and ASPs 2050, and ASPs 2050 and issuer PNIP 2024 are referred to as a network interface onto the payment card network itself (elements 2050 are discussed below). In one or more embodiments, this may be a TCP/IP connection (as seen at 2026) with customized routing capabilities including group addresses. Normally, TCP/IP addresses refer to a single endpoint. Group addresses may be directed to a group of addresses, and will target any of the computers (e.g., PNIPs) in the group using a variety of protocols. Some use a round robin approach; others may use a first in list approach where the message is always routed to one given computer first and then to a second computer only if the first is not available. Group addressing may be useful, for example, where an acquirer or issuer has multiple PNIPS at the same location for redundancy/fault tolerance. It is also possible to combine the approach and institute a round robin, wherein the addresses within the round robin are first in list group address, or conversely, it is possible to institute a first-in-list, wherein the addresses within the first-in-list are round robin group addresses. These capabilities are useful in case of outages, maintenance, and the like.

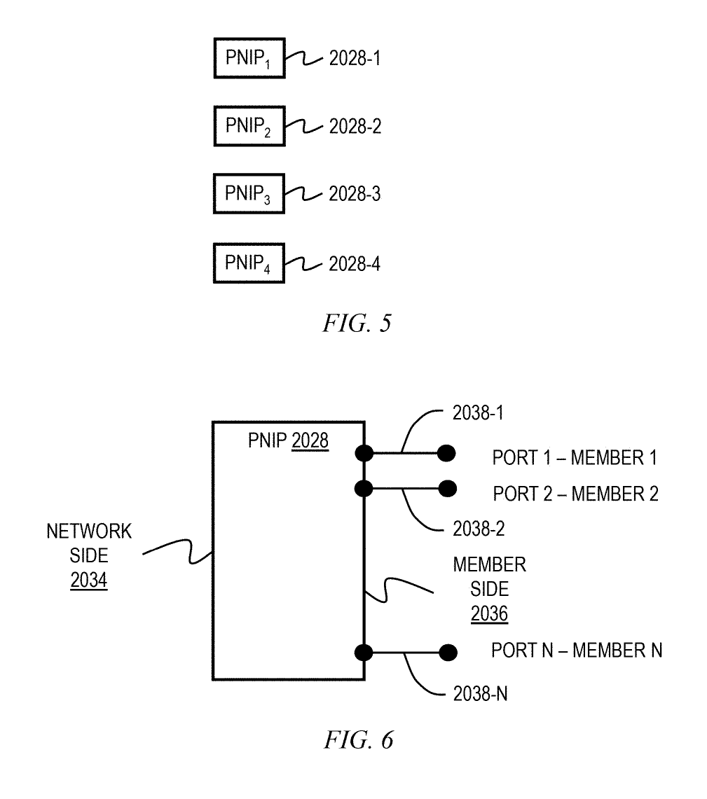

FIG. 5 shows a non-limiting example with four PNIPs 2028-1 through 2028-4. In a round robin approach, a first message is routed first to PNIP 2028-1, a second message to PNIP 2028-2, a third message to PNIP 2028-3, a fourth message to PNIP 2028-4, a fifth message to PNIP 2028-1, and so on. In a first in list approach, all messages are routed to PNIP 2028-1; if it is not available for a given message, the message is routed to PNIP 2028-2; if PNIP 2028-2 is not available, the message is routed to PNIP 2028-3; if PNIP 2028-3 is not available, the message is routed to 2028-4. Each PNIP 2028-1 through 2028-4 in FIG. 5 could be a single machine or a group of machines addressed by first in list or round robin as discussed just above. In one or more embodiments, the physical network 2026 between PNIPs 2012, 2024 and the physical network 2030, 2032 between PNIPs 2012, 2024 and the central site 2009 is a private Multiprotocol Label Switching (MPLS) TCP/IP network and is not the Internet. Once the issuer's network group address has been determined by the PNIP 2012 (or ASP 2050), the message is routed to the issuer PNIP 2024. Once the 0100 auth message arrives at the issuer PNIP 2024, additional edits are performed to double check and make sure that the message has been routed to the correct location. Furthermore, the member ID is examined, because some issuers may share a single PNIP and it is necessary to determine which of the issuers (members) sharing that PNIP the transaction in question is to be routed to. Each of the issuers sharing the PNIP will have its own port on the member side of the PNIP; the transaction is routed to the appropriate port based on the member parameters. See FIG. 6 where a generalized PNIP 2028 has a network side 2034 and a member side 2036. Member side 2036 has N ports 2038-1 through 2038-N to members 1 to N. N is used herein as a generalized arbitrary integer and the value of N in FIG. 6 is not necessarily the same as that of N in connection with elements 2002 in FIG. 2, for example.

As seen in FIG. 7, in some instances, an issuer has multiple PNIP devices 2028 at a single site, with a network-side connection 2034, and with multiple PNIPs 2028 all connected to the same host system (each has port 1 2038-1 associated with the same member (issuer)).

At this point, the 0100 message has been delivered to the issuer 2010. The issuer 2010 then carries out issuer processing and decisioning (e.g., with issuer processing platform 2040) based on transaction velocities, open to buy, fraud detection protocols, etc., and provides an appropriate authorization request response, ISO 8583 MTI 0110. There are a number of different possible response codes defined within ISO 8583 and its particular implementations. Each transaction is made up of multiple data elements; the response from the issuer is included in data element 39. Once the 0110 message is received on the issuer PNIP 2024 from platform 2040 it is parsed and edited for format, content, and context, including validation of DE39 to make sure that it is a valid value.

It is worth noting that in one or more instances, at every point where a transaction touches a computer of the payment card network, whether it be an acquirer PNIP 2012, issuer PNIP 2024, or a special services computer or computers 2050 at the central location 2009 (discussed below), transaction context is preserved. That is to say, before the message is sent on to the next node in the network, a copy is saved in a context manager queue 2042, 2046, 2058, so that when the transaction response MTI 0110 comes back through, the request MTI 0100 can be matched with the response, in order to know how to route the response back to the previous route point. One of the items saved in the context manager queue is the message originator's address, so that it can be used for route-back information. Once the issuer PNIP validation is complete, including format, content, and context edits, the transaction is extracted from the context manager queue 2046 and the route-back address is retrieved, and the 0110 message is then sent back where it came from; in this case, the acquirer PNIP 2012 (or ASP 2050). The acquirer PNIP 2012 then receives and parses the message and pulls its original request out of its context manager queue 2042. Note that multiple acquirers may share an acquirer PNIP and it is therefore necessary to know which port on the acquirer PNIP to route the response back to (see discussion of FIG. 6). Checking the message against the original request in the context manager queue allows the message to be routed back to the correct port.

Each PNIP 2012, 2024 typically has many different programs. These can include, for example, a parser/editor 2020, 2043; a parameter file manager; a transaction context manager; a member communications program; a network communications program; and the like. Please note that to reduce clutter, FIGS. 3 and 4 show “MPS extract” 2022, 2044; this will typically include the extract itself and the associated parameter file manager which manages obtaining the extracts from MPS 2018. Similarly, to reduce clutter, FIGS. 3 and 4 show “context manager queue” 2042, 2046; this will typically include the queue itself and the associated manager which manages the contents of the queue. In one or more embodiments, there is also a communication program used to communicate between the other programs (inter-process communications) on the PNIP; this is omitted from FIGS. 3 and 4 to avoid clutter.

Messages in case of Enhanced Services: In one or more instances, a special architecture is used to facilitate delivery of enhanced services (the ASP 2050 in FIG. 4 is a non-limiting example). Examples of enhanced services include the MASTERCARD IN CONTROL product providing spending controls and/or virtual card numbers (MASTERCARD IN CONTROL is generally representative of spend control systems, card control systems, and the like, and embodiments indicated as employing MASTERCARD IN CONTROL are not intended to imply any limitation to one particular spend control and/or card control system). Other examples of enhanced services are loyalty rewards, recurring payment cancellations, and the like. One or more instances do not deploy this complex logic out to the network edge. Furthermore in this regard, the issuer and acquirer PNIPs 2012, 2024 are referred to as being on the edge because they reside on the customer's premises 2006, 2010. There may be over 2000 PNIPs on a typical network. The special architecture used in one or more instances is a central site type architecture associated with location 2009. At the central site 2009, certain computers are referred to as authorization services processors or ASPs 2050.

On the acquirer PNIP 2012, when checking the member parameter file for an account range, determine whether the transaction requires enhanced services. If yes, the transactions is routed to the central site ASPs 2050, which have interfaces to all of the service provider systems—the ASPs do not necessarily provide the services themselves (although they can in some embodiments), but may mediate between the network (e.g., BANKNET) and the actual service providers 2051-1 through 2051-N. An ASP will typically have connections 2053 to a mainframe 2052 via DB2 connect or other suitable connection. If a transaction is to be enriched with additional data, a database call will be made to the mainframe 2052 to retrieve the information from mainframe database 2054 so that it can be inserted into the transaction before the transaction is forwarded to the issuers. Interfaces can also be provided to a risk management system, a decisioning management system, MASTERCARD IN CONTROL, rewards, and the like. Service providers 2051-1 through 2051-N generally represent any enhanced services, non-limiting examples of which have been given herein.

A communications layer 2056 is used to communicate with the service providers in one or more embodiments, a non-limiting example of a suitable implementation is the IBM MQ series. The 0100 message may be sent to the service providers, optionally encapsulated inside a special “enhanced services” (ES) header that wraps the message with any additional information required to fulfill the service. The service provider sends a response. The ASP takes the response and enriches the 0100 transaction with the service response, and then sends the entire package on to the issuer PNIP 2024. Some enhanced services are processed on the request messages (0100) and others are processed on the response messages (0110). Once the response message is processed on the ASP, the original message will be pulled from the context manager queue 2058 on the ASP to determine the appropriate acquirer PNIP 2012 to route the message back to. From there, the acquirer PNIP will behave just as in the “Messages routed directly to the issuer PNIP” case discussed above. Some embodiments of the special architecture use an Enterprise Service Bus to mediate and facilitate some of the services 2051. For example, the MASTERCARD IN CONTROL service can be accessed via an instance of an Enterprise Service Bus.

Entry of Data into the Data Warehouse:

In one or more instances, every transaction that flows through the issuer PNIP 2012, acquirer PNIP 2024, and/or ASPs 2050 is logged at every point by writing log records. Multiple times a day (e.g., six), a global file transfer system 2059 pulls the logs off each node and collects them into a support files system 2060 on the mainframe 2052. The log files are parsed and collected into a general daily file. The general daily file is scrubbed and modified to create a consolidated file on the mainframe which is then pulled into the data warehouse 2062, where additional data manipulation and scrubbing are performed before the transactions are stored. The data warehouse 2062 is located at an intermediate node (location 2009) connected to the PNIPs of the acquirers and issuers 2012, 2024. By way of clarification, in one or more embodiments, the node 2009 is directly connected to the PNIPs 2012, 2024 but the data warehouse is not directly connected to the 2012 and 2024 devices; rather, data flows through GFT and SF systems 2059, 2060 and ends up in the data warehouse. Data warehouse 2062 should be distinguished from a data warehouse 154 that might be maintained by an issuer.

Clearing and Settlement:

One or more instances employ a clearing and settlement system 2074. In clearing, via global file transfer 2059, acquirers submit clearing files in an appropriate message format (in a non-limiting example, Integrated Product Messages (IPM) format). The files contain, from the acquirers' perspective, what they believe they should be paid for. In one or more instances, the authorization does not actually move any money; the authorization only validates that the cardholder is a valid cardholder recognized by the bank, which will honor payment to the merchant for the goods or services. For example, in a typical restaurant visit, the card is swiped for the receipt amount but then a tip is added. The clearing message will have the actual food amount plus the tip. In one or more instances, the clearing does not actually move the money; it merely resolves the actual amounts. The settlement system actually initiates movement of the money. Furthermore in this regard, the settlement system actually tells the banks how much money to move but does not actually move the money. Within clearing, processes include dispute resolution, chargeback, and the like. During clearing, files are sent from the acquirers to the payment card network; the payment card network, using clearing and settlement system 2074, then takes the files and splits them and sorts them by issuer. Response files are then received from each issuer, and these response files are again split and re-sorted back to the correct acquirers. Eventually, data flows into the settlement system and money is moved. Thus, at a high level, the auth request and auth request response are in real time, and the clearing and settlement are in a batch mode.

By way of review and provision of additional detail, in at least some instances, in a batch mode, clearing is initiated via an ISO 8583 MTI 1240 message having a DE24 function code value of 200 for a first presentment. Once this message is obtained from the acquirer, the payment card network, using clearing and settlement system 2074, will undertake syntax edits, format edits, content edits, and context edits (typically applied to every transaction). If those edits are passed, the interchange and fees associated with the transaction will be calculated. Based on the calculations, the message may also be enriched with additional information before being passed on to the issuer. The settlement amount is then determined. Within the clearing cycle, the amounts of money due to each given member (e.g., issuer or acquirer) are accumulated, and these are summed up into a settlement file which is forwarded in due course.

Cryptographic Aspects:

Consider the concepts of data at rest and data in motion. An example of data at rest is the log files that actually reside on the PNIPS themselves—configuration information containing card numbers or personally identifiable information (PII). In one or more embodiments, all sensitive data at rest is encrypted before being written to disk. Data in motion refers to data actually moving over a transmission medium (e.g., wires, coaxial cable, fiber optic cable, RF link). All PCI-sensitive data (PCI Security Standards Council, LLC, Wakefield, Mass. US) is encrypted, whether written to disk or being sent over a network. In at least some instances, internal links within the premises of the acquirers and issuers are not encrypted since it is assumed that the customer premises are a physically secure facility relying on physical security of the hardware. On the other hand, in at least some instances, external links (e.g., links 2026, 2030 and 2032) are all encrypted for both authorization traffic and bulk file transfers.

One or more embodiments will have interface(s) 2068 to other brands of payment card processing network. For example, a MASTERCARD branded payment card processing network may have interfaces to networks such as AMERICAN EXPRESS, VISA, JCB, DISCOVER, and the like. Suitable translation layers can be provided to intermediate between MASTERCARD (or other) format and formats used by other networks, as appropriate. In one or more embodiments, interfaces 2068 to other payment networks are provided via a machine, located at 2009, but generally analogous to an Issuer PNIP 2024 with added mediation layers loaded as required by other payment network formats. Some merchants may only have a single interface to, e.g., the MASTERCARD network—all transactions from that merchant may be routed to MASTERCARD, regardless of what card was used—MASTERCARD will process those transactions and route them out to the appropriate networks.

Mobile vendors (e.g., food trucks, pop-up stores) may accept payment cards using, e.g., mobile devices (for example via the SQUARE® hardware and software for processing credit card, debit card, and gift card transactions via mobile devices, mark of SQUARE, INC., San Francisco, Calif., USA) or wireless terminals (for example the Verifone® VX680 wireless terminal, mark of VERIFONE, INC., SANTA CLARA Calif., USA).

### Exemplary Mobile Device

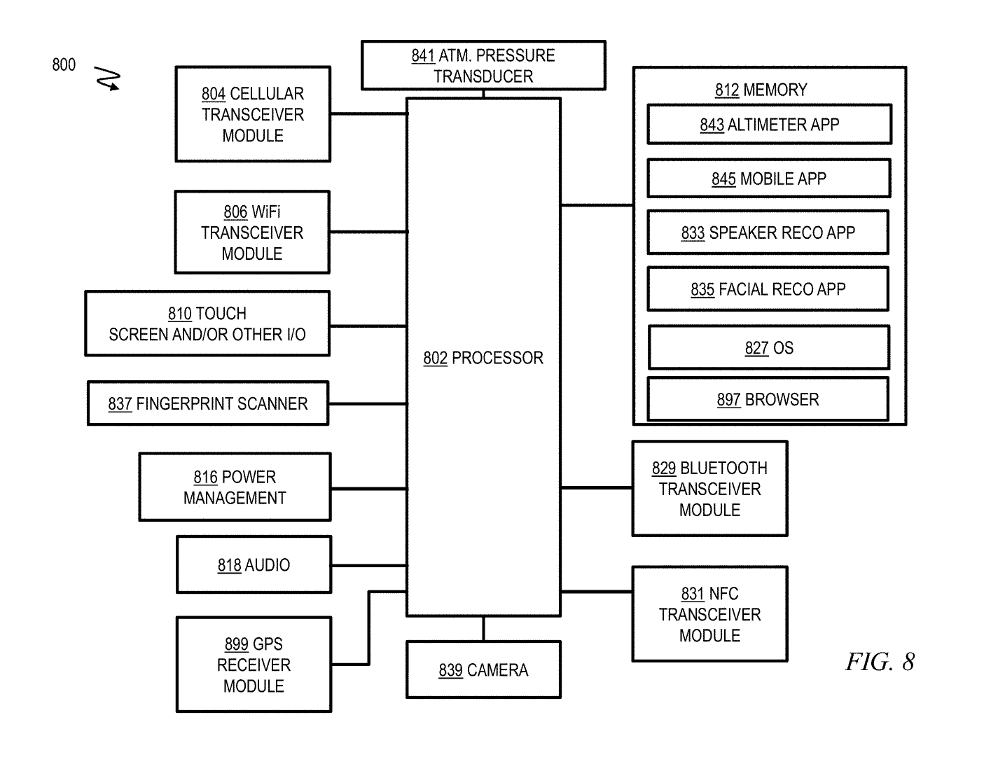

FIG. 8 is a block diagram of an exemplary tablet computing device, netbook, “Ultrabook” or other subnotebook, laptop, mobile electronic device, or smart phone 800 or the like. Unit 800 includes a suitable processor; e.g., a microprocessor 802. A cellular transceiver module 804 coupled to processor 802 includes an antenna and appropriate circuitry to send and receive cellular telephone signals, e.g., 3G or 4G. In some cases, a Wi-Fi transceiver module 806 coupled to processor 802 includes an antenna and appropriate circuitry to allow unit 800 to connect to the Internet via a wireless network access point or hotspot. The skilled artisan will appreciate that “Wi-Fi” is a trademark of the Wi-Fi Alliance and the brand name for products using the IEEE 802.11 family of standards. In some cases, a Bluetooth transceiver module 829 coupled to processor 802 includes an antenna and appropriate circuitry to allow unit 800 to connect to other devices via the Bluetooth wireless technology standard. In some cases, an NFC transceiver module 831 coupled to processor 802 includes an antenna and appropriate circuitry to allow unit 800 to establish radio communication via near-field communications.

Operating system (OS) 827 orchestrates the operation of unit 800. Apple's iOS and Google's Android are non-limiting examples of suitable operating systems.

Touch screen 810 coupled to processor 802 is also generally indicative of a variety of input/output (I/O) devices such as a keypad, another type of display, a mouse or other pointing device, and so on, all of which may or may not be present in one or more embodiments. Audio module 818 coupled to processor 802 includes, for example, an audio coder/decoder (codec), speaker, headphone jack, microphone, and so on. Power management system 816 can include a battery charger, an interface to a battery, and so on. Memory 812 is coupled to processor 802. Memory 812 can include, for example, volatile memory such as RAM, and non-volatile memory such as ROM, flash, or any tangible computer-readable recordable storage medium which stores information in a non-transitory manner. Processor 802 will typically also have on-chip memory.

In some cases, fingerprint scanner 837 is coupled to processor 802 for biometric authentication purposes. An appropriate corresponding software application (not separately depicted) may reside in memory 812 in some instances. A digital camera 839 is coupled to processor 802. Camera 839 can optionally be used in conjunction with a facial recognition application 835 in memory 812 for biometric verification. A microphone in audio module 818 can optionally be used in conjunction with a speaker recognition application 833 in memory 812 for biometric verification; a suitable acoustic front end can be provided.

A GPS receiver module 899 coupled to processor 802 includes an antenna and appropriate circuitry to allow device 800 to calculate its position by precisely timing the signals sent by GPS satellites high above the Earth. Corresponding software resides in memory 812.

Memory 812 can also include, for example, a stored PIN for comparison with a PIN entered via touch screen 810; extracted facial features from the legitimate owner of the phone for comparison with facial features extracted from a picture taken by camera 839; extracted fingerprint features from the legitimate owner of the phone for comparison with fingerprint features obtained from a scan carried out by scanner 837; and/or extracted voice features from the legitimate owner of the phone for comparison with voice features extracted from a voice sample obtained from a microphone in audio module 818. Note that elements in FIG. 8 are shown connected directly to processor 802; however, one or more bus structures can be employed in one or more embodiments. Furthermore, elements shown as implemented in software may be implemented at least in part in hardware for speed, if desired.

Browser program 897 in memory 812 deciphers hypertext markup language (html) served out by a server such as 900 (discussed below) for display on screen 810 or the like.

Atmospheric pressure transducer 841 senses atmospheric pressure, which can be converted to altitude by altimeter application 843 using formulas that are, in and of themselves, well-known.

Application 845 in memory 812 is discussed below.

Every instance need not necessarily have every feature depicted in FIG. 8. For example, some embodiments may primarily use the GPS functionality, processor, memory, app 855 and/or browser 897, and module(s) 804 and/or 806.

### Correlating Global Positioning System Data and ISO 8583 Network Transaction Data

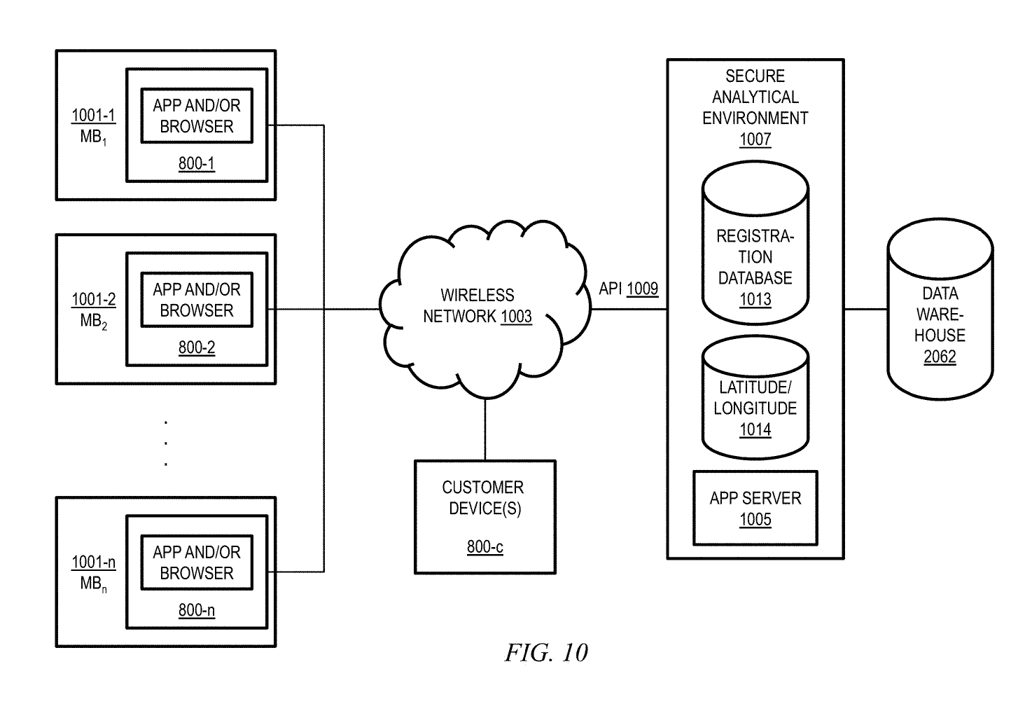

Food carts and other mobile businesses are interested in understanding business performance and opportunity by geographic location. The goal is to better understand performance as compared to the competition and to identify and select optimal sites. Referring to FIG. 10, in one or more embodiments, one or more food carts or other mobile businesses MB₁, MB₂ . . . MBₙ, numbered 1001-1, 1001-2, 1001-n, and having mobile devices 800-1, 800-2 . . . 800-n (generally 800), track and submit their latitude and longitude together with time of day via a mobile application such as 845 (or other technology; e.g., code executed by browser(s) 897) to an operator of an ISO 8583 network 2008 or the like (e.g. environment 1007 thereof, discussed below). The app and browser are not separately numbered in FIG. 10 to avoid clutter. The operator of the network 2008 complements this information with spend data (e.g. from data warehouse 2062) of the food cart(s) or other mobile business(es) (and optionally that of other local businesses, including fixed or “brick and mortar” businesses) based on longitude, latitude, and time of day, to provide insights regarding business performance against the competition and/or location selection insights. Business performance metrics may include metrics such as industry volume and share of market (for food vendors, colloquially referred to as “share of stomach”) for specific locations by time of day.

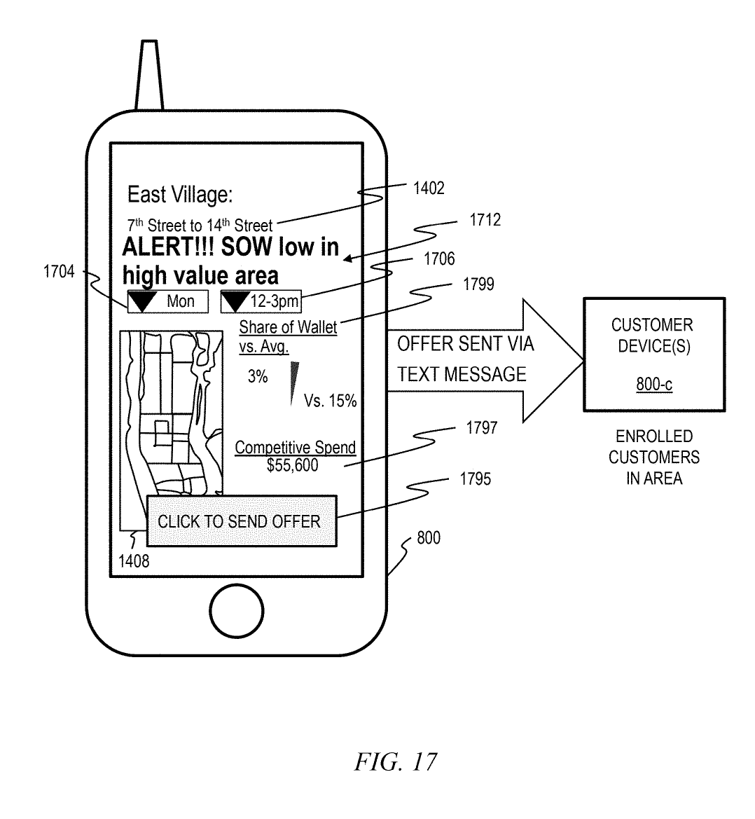

One or more customer mobile devices 800-c are in wireless communication with network 1003 and can receive, e.g., text and/or e-mail alerts, offers, etc. as discussed below with respect to FIG. 17.

Further additional exemplary details will now be provided. In one or more embodiments, a food truck or other mobile business agrees to use mobile app 845 (or another method such as mobile internet technology—see browser 897) to track the latitude and longitude of the food truck (in a non-limiting example, to the sixth decimal place). Mobile app 845 (or other method) tracks the latitude and longitude of the food truck or other mobile business during the course of the day. The tracking may be done periodically (e.g., every minute) or at other regular or irregular intervals. The data is saved in a location log that is in, or accessible to, the app 845 in memory 812. The location logs are sent to the operator of the network 2008 as discussed further below and matched (e.g., via suitable database queries) to the transaction data of the food truck or other mobile business by time to understand the location of the truck for a particular transaction. The matched data permits development of business insights which can be provided to the food truck or other mobile business, such as business performance by location and time of day/day of week and headroom opportunity (i.e., potential profits—spending at competitors and thus the opportunity to increase profits). The data also allows for understanding eating needs by neighborhood. Indeed, examples of insights that can be gleaned include business performance by location and time of day/day of week, e.g. share of wallet, average ticket, customer demographics (e.g., age, income, gender, and the like); and/or opportunity by location and time of day/day of week (headroom for location). This allows the food truck or other mobile business to select optimal locations by time of day and day of week to grow sales volume and gain market share; adjust menu and/or pricing based on the eating needs of the neighborhood; and/or customize mobile marketing offers based on these needs. Note that known techniques can be used to associate demographics to payment card account holders.

It should be noted that if many food trucks or other mobile businesses opt in to sending location data, the operator of the network 2008 can create industry-level food truck analytics (or comparable analytics for other mobile businesses) to make available to appropriate parties (of course, with due regard for all applicable privacy laws, rules, regulations, and ethical standards—proper permissions required). In one or more embodiments, cardholder data is shared with mobile food vendors or other mobile businesses only upon opt-in by the cardholders.

The information provided to the food truck(s) or other mobile business(es) can be employed for many useful purposes. For example, the food truck(s) or other mobile business(es) can adjust menu and/or pricing based on the eating needs of the neighborhood and send a text message to enrolled customers in the neighborhood regarding offers and menu changes; and/or the location of the food truck(s) or other mobile business(es) can change dynamically based on a separate proxy for high levels of consumer footfall (transaction volume index) delivered in real time. Furthermore in this regard, as discussed below, footfall is usually determined by the number of individuals in a particular area. A proxy can be provided based on the number of total transactions (or number of, e.g., food-related transactions) in an area. In another aspect, live updates can be sent to the food truck(s) or other mobile business(es) and SMS (or other) text messages can be sent to enrolled consumers telling them about location and daily specials and offers. Furthermore, neighborhoods with low share of wallet can trigger automatic alerts to the food truck(s) or other mobile business(es) and automatic text messages and/or emails to enrolled consumers on specials, to help improve share of wallet in key high spending areas.

Referring still to FIG. 10, in a specific (but non-limiting) detailed embodiment, the food truck driver downloads mobile app 845 to his or her cell phone 800 and opts in to the program. This can be carried out, for example, by making the app available on application server 1005 over wireless network 1003 (e.g., 3G or 4G), via a Wi-Fi connection, or the like. Application server 1005 is shown within secure analytical environment 1007, discussed below, but can be located elsewhere and operated by or at least in part on behalf of the operator of the network 2008 (e.g., made available in a third-party “app store”). The food truck driver provides pertinent information (name, address, phone number, etc.) upon registration to identify the associated merchant identifier (Merchant ID) defined by the payment card processing network (e.g., MasterCard Location ID—payment card networks generally assign an alphanumeric identifier to a merchant; this identifier can generally be retrieved by the operator of the payment card network based on the merchant's name, address, telephone number and/or other characteristics to identify the business). The registration information is stored in registration database 1013. App 845 collects the latitude and longitude of the cell phone 800 utilizing GPS technology 899 and stores this information within the mobile app in memory 812; in an alternative approach, this information is provided by the telephone service provider (e.g., wireless network operator). At the end, e.g., of each day or week, the log of information collected is sent from the mobile app 845 to the operator of the network 2008 (e.g., environment 1007) and stored in database 1014; for example, via application programming interface (API) technology or the like, in an automated fashion. In one or more embodiments, the API 1009 is created by the operator of the payment card processing network to allow the mobile business owner to submit the data on a recurring basis. The operator of the network 2008 exposes the API from a server (e.g., a server on which environment 1007 resides) to the Internet where it can be accessed wirelessly by app 845 and/or by code executing in browser 897. The operator of the network 2008 transfers the logs to a suitable secure analytical environment 1007 (e.g., Citrix® environment, registered mark of CITRIX SYSTEMS, INC. FT. LAUDERDALE FLORIDA USA) and combines the log(s) with transaction data for the appropriate location ID from the MasterCard Clearing Database (or other Merchant ID). This can be done, for example, by carrying out a database query on the appropriate fields and looking for a match. Analytics can be carried out based on the location of the food truck, location of competing businesses, and the demographics of accounts using, e.g., SAS software from the SAS Institute Inc., Cary, N.C., USA; the “R” programming language and software environment for statistical computing and graphics; or other statistical, analytics and/or database software.

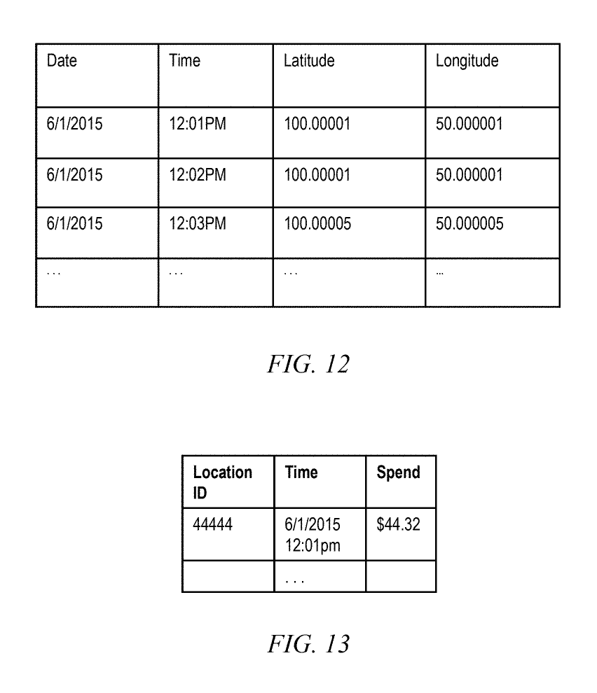

FIG. 12 shows an exemplary location log (latitude and longitude of a mobile business as a function of date and time) and FIG. 13 shows exemplary transaction data from a clearing database; e.g., entries in data warehouse 2062 made by clearing and settlement system 2074.

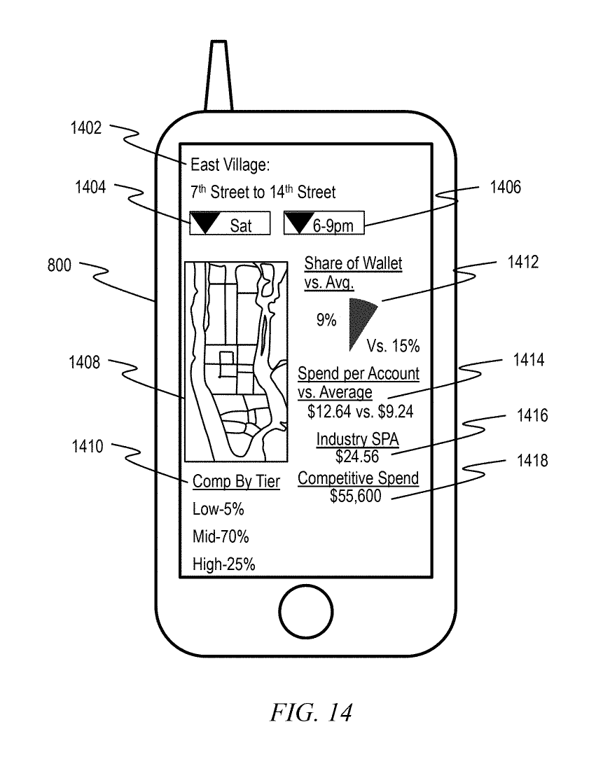

FIGS. 14-17 show exemplary screens of a mobile device 800 of a food truck driver using an embodiment of the invention. In FIG. 14, the user has selected a particular geography or neighborhood 1402; here, the East Village neighborhood in Manhattan (defined as 7^{th} Street through 14^{th} Street). The user may select the desired neighborhood from, for example, map 1408. The user selects a day 1404 and time period 1406 for which it is desired to see the performance of the food truck and the opportunity in the area. Here, the user desires to determine his or her food truck's share of wallet on Saturday from 6 to 9 PM. In the non-limiting example of FIG. 14, as seen at 1412, 9% of all restaurant or eatery spend is accounted for by the food truck; however, the average performance is 15%, so it can be determined that this food truck is actually underperforming in this area at this time period. The spending per account 1414 compares the spending per account for this food truck to the average Here, even though the share of wallet is lower, this food truck is attracting a higher average ticket size or spend per account. The industry spend per account (SPA) 1496 is $24.56 across all eateries in the neighborhood, showing that people spend more money on average than they are spending at this food truck. The competitive spending 1418 is $55,600 (headroom or total volume at eateries in this neighborhood on Saturdays from 6-9 PM). “Comp by Tier” 1410 compares average ticket amount among competitors in the East Village neighborhood; low, mid, and high can be predefined for each neighborhood; e.g., low ticket is less than $10, medium is $10-30, and high is greater than $30. This neighborhood exhibits primarily mid-tier restaurants.

As seen at 1404, 1406, arrows permit scrolling through the menus for desired items to display—e.g., day of the week at 1404 and time of day at 1406.

In one or more embodiments, the data shown in FIGS. 14-17 is based on general payment card transaction data (e.g., for eateries in this particular neighborhood, based on merchant category code (MCC) or the like) as well as specific records for this food truck. In an alternative approach, if enough food trucks opt in to participation, further details can be provided to compare to other food trucks as well.

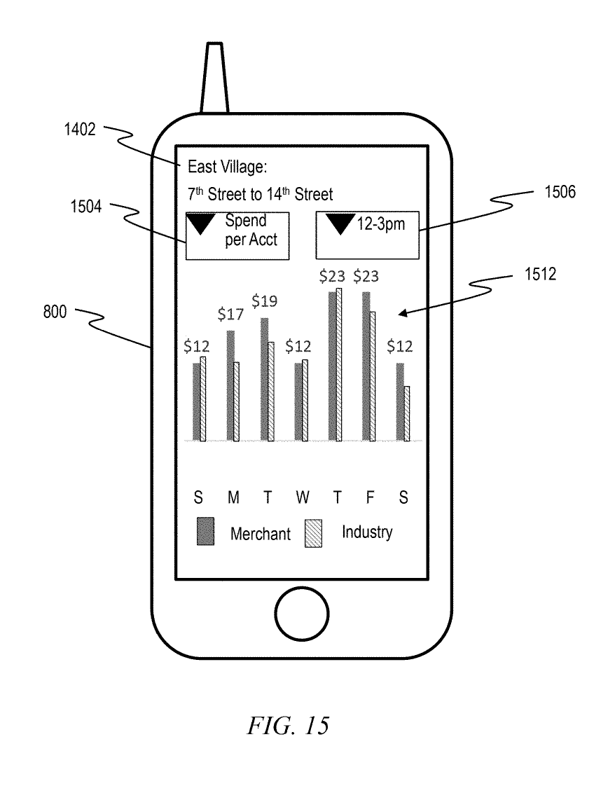

FIG. 15 shows, for the East Village, spend per account 1504 from 12-3 PM 1506 for each day Sunday through Saturday, for the merchant (solid) versus the industry (hatched), as seen at 1512. Purely for purposes of avoiding clutter, the numerical value is also shown for the merchant for each day (i.e., $12, $17, $19, $12, $23, $23, $12) but is not shown for the industry; however, the numerical value could be shown for both, either, or neither.

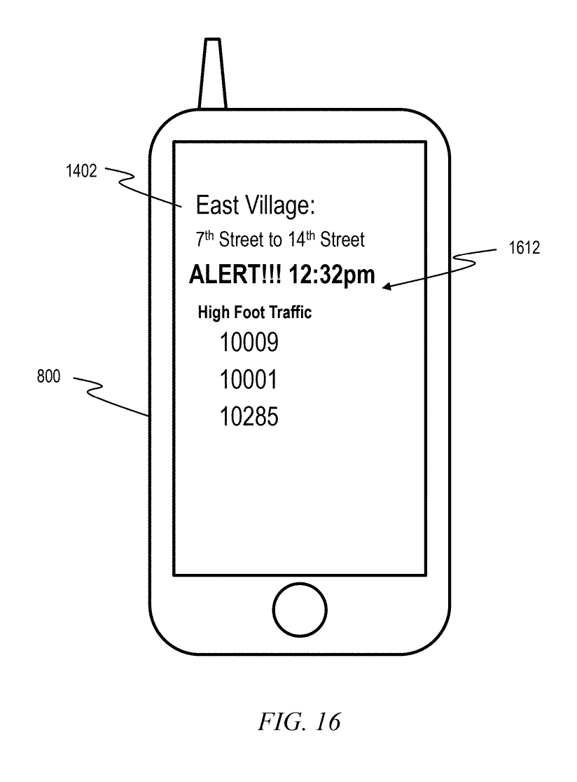

FIG. 16 depicts an alert 1612 to let the food truck driver know where there is high foot traffic, based on a high volume of transactions at the three indicated zip codes. Optionally, the geographic areas corresponding to the zip codes can be identified and/or the amount of foot traffic can be quantified by providing a relative index or the absolute numbers of transactions (used as a proxy for foot traffic).

In FIG. 17, the food truck driver receives an alert 1712 to notify him or her that there is an opportunity (the food truck's share of wallet “SOW” is low in a high value area). The driver is afforded the opportunity to act on the alert by sending a text message to mobile devices 800-c of previously enrolled individuals who are in the area, to notify them of a special offer, by selecting the “click to send offer” screen region 1795. Third party text messaging service companies can help the food truck execute text message offers. Alternatively or in addition, offers can be generated by another entity such as the payment card network operator. Elements 1704, 1706 are analogous to elements 1404, 1406. Elements 1799, 1797 are analogous to elements 1412, 1418.

Thus, in one or more embodiments, an entity such as the operator of a network 2008 or the like provides a mobile app 845 to a food truck or other mobile business; the app tracks the latitude and longitude of the food truck or other mobile business throughout the day (e.g., every minute). This information (latitude, longitude, time of day) is sent to the entity to match back to transaction files for that food truck or other mobile business so that the entity can understand where the food truck or other mobile business is when a transaction occurs. With that information, the entity can provide business performance metrics by location, time of day, and day of week. Metrics can include share of wallet, headroom opportunity in terms of what type of eatery spend is happening at that location at that time, and so on. The food truck or other mobile business can use this information to select the best locations to operate by time of day and day of week in order to grow sales volume and market share. The food truck or other mobile business can also use this information to adjust pricing and menu based on the eating needs of a neighborhood. The information can also be used to customize marketing offers to consumers; e.g., based on the needs of the location, text messages can be sent to consumers with offers. If there is a high headroom opportunity and the truck has a low share of wallet, and people in a given area are eating a certain type of food or the transaction history of enrolled customers in a given area indicates a preference for certain types of food, the truck can send out targeted offers and/or adjust the menu that it offers. If multiple food trucks opt into the program, it is possible to provide industry level food truck analytics and aggregate what is happening in the food truck industry.

Again, while one or more non-limiting exemplary embodiments are presented in the context of a food truck, aspects of the invention are applicable to a variety of mobile businesses; e.g., vendors, pop-up stores. As noted, it is also possible to provide food trucks with a real-time proxy for consumer footfall. Footfall is usually determined by the number of individuals in a particular area. A proxy can be provided based on the number of total transactions in an area. Live updates can be provided to the food truck, to let the truck know of, e.g., the top 5 or 10 areas with a transaction volume spike so the truck can consider moving to a new location. Insights can be provided to the truck and can trigger text messages and/or e-mails to consumers as well.

Once the latitude, longitude, and time of day are obtained by the entity, the entity can query the data warehouse 2062 for transactions that correlate to the merchant ID of the food truck or other mobile business; i.e., match back to transaction files for that food truck or other mobile business so that the entity can understand where the food truck or other mobile business is when a transaction occurs.

### Recapitulation

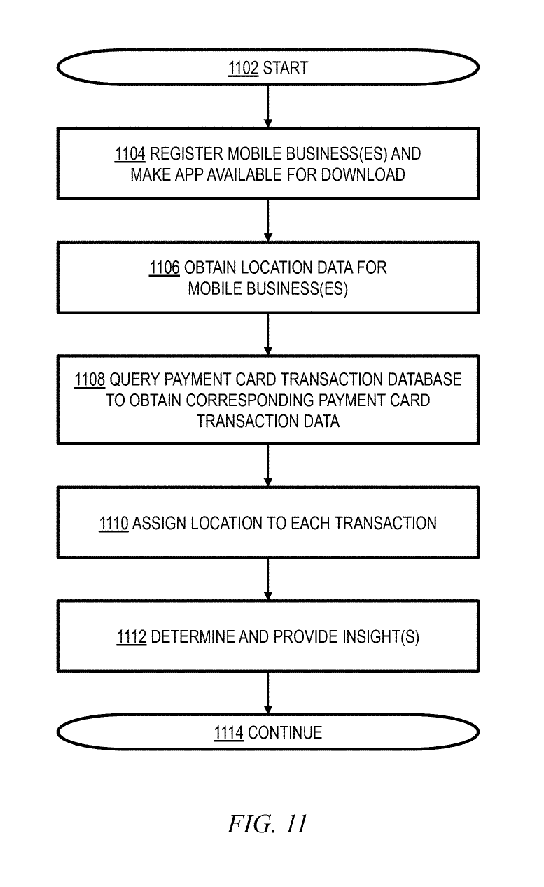

Given the discussion thus far, and referring to the flow chart of FIG. 11, which begins at 1102, it will be appreciated that, in general terms, an exemplary method, according to an aspect of the invention, includes the step 1104 of making a mobile application 845 available for download to a mobile device 800 associated with a mobile business 1001 (optionally, also with registration). A further step includes obtaining, from the mobile business 1001, data (e.g. table of FIG. 12) describing a varying location of the mobile business over a time period of interest, by exposing an application programming interface 1009 to the mobile application over a wireless network 1003. The data also includes an identifying indicia of the mobile business (e.g., above-mentioned alphanumeric identifier payment card network assigns to a merchant). The varying location of the mobile business over the time period of interest is tracked by the mobile application interfacing with a global positioning system unit 899 of the mobile device associated with the mobile business. This step can thus be carried out, for example, via app 845 interfacing with GPS module 899 to gather the longitude and latitude data as a function of time, and then periodically sending this data via API functionality 1009. In an alternative embodiment, as discussed further below, HTML code executing in the browser 897 interfaces with module 899 or the data is obtained from the phone company, a GPS unit of the food truck itself, or the like.

A further step 1108 includes querying a database 2062 of payment card transactions based on the identifying indicia of the mobile business to obtain payment card transaction data for a plurality of transactions at the mobile business during the time of interest. The payment card transaction data includes, for each of the transactions, amount and time stamp (as seen in the table of FIG. 13). This step can be carried out, for example, by querying a database (e.g., warehouse 2062 including the just-mentioned payment card transaction data) based on the Location ID and a time/date range of interest, using a suitable database program.

A still further step 1110 includes assigning, to each of the transactions, a location, based on matching the time stamps of each of the transactions with a corresponding location in the data describing the varying location of the mobile business over the time period of interest, to obtain augmented transaction data. For example, logic is written to assign the latitude and longitude of the closest time-stamped record in the table of FIG. 12 to the transaction in the table of FIG. 13. The $44.32 would be assigned to latitude 100.000001, longitude 50.000001 based on the 12:01 PM Jun. 1, 2015 time stamp. If there is not an exact match, the logic picks the closest entry; if 2 entries are equidistant, the logic includes a rounding rule to pick one or the other; or alternatively, interpolates the latitude and longitude using linear interpolation or a curve fit. This functionality can be implemented, for example, via a database program running on a server providing the environment 1007; e.g., R, SAS, or the like.

An even further step includes sending an alert to the mobile application based on the augmented transaction data (see, e.g., discussion of FIGS. 16 and 17).

As discussed with regard to FIG. 17, in some cases, a further step includes affording a user of the mobile application an option (see 1795) to initiate targeted offers for the mobile business, based on the augmented transaction data. In some cases, an entity (e.g., an operator of a payment card network 2008) obtains a communication from the user of the mobile application to initiate the targeted offers; this entity may itself initiate the targeted offers in response or may, in response, initiate a communication with a third party to provide the targeted offers.

Step 1104 includes registering the mobile business (can also optionally include making the mobile app available as discussed elsewhere). This registration can include, for example, gathering the name, address, phone, and e-mail of the business so as to be able to identify the merchant in the database of the payment card network operator. Alternatively, an identifier can be assigned during registration 1104 or when a given merchant signs up to accept a certain brand of payment card. In general, during registration, what is obtained is information to link the latitude and longitude with the transactions. Registration can be carried out, for example, via a web-based process (e.g., via a server serving out HTML code to a browser of a user's machine to form a graphical user interface); via app 845; when originally signing up to accept a certain brand of payment card; or the like.

In some cases, a further optional step 1112 is included; namely determining and/or providing insights—for example, providing the mobile business with at least one insight derived from the augmented transaction data, based on information obtained during the registration. For example, the insights are provided to the e-mail address or phone number (e.g. via a text message) obtained during the registration process. In other embodiments, insights are provided upon login via browser 897; or via app 845.

Processing continues at 1114.

Non-limiting examples of the at least one insight that can be provided include performance by time of day, day of week, and location, as discussed with regard to FIGS. 14-16.

Making the mobile application 845 available for download to the mobile device associated with the mobile business can be done during the registration process or at another time. The mobile device tracks the varying location of the mobile business over the time period of interest, by interfacing with the global positioning system unit 899 of the mobile device associated with the mobile business.

As noted, in some instances, the mobile application includes an option 1795 to initiate targeted offers for the mobile business. Furthermore in this regard, in some cases, the operator of the payment network 2008 develops technology to allow the mobile business owner to initiate the offer by clicking the link to send out text messages; in another approach, an interface with a third party form is employed.

It will be appreciated that the mobile business can be associated with a particular business category; for example, “restaurants,” or more particularly “food trucks.” A merchant category code (MCC) is a non-limiting example of a business category. In some cases, the at least one insight includes a fraction (optionally in the form of a percentage) of total spending in the business category for the mobile business for a given time of day, day of week, and location. See, e.g., item 1412 in FIG. 14. A further optional step includes calculating the fraction. This can be done, for example, by adding up all the spending for the mobile business for the day, time, and location of interest, and also determining the total spending for the business category of interest (e.g., querying data warehouse 2062 for all transaction with a given MCC, time, date, and location and summing them); then dividing to determine the fraction, and optionally multiplying by 100 to obtain the percentage.

Optionally, the mobile business is further provided with an average fraction of total spending in the business category for an average business in the business category for the given time of day, day of week, and location. This can be done, for example, by querying data warehouse 2062 for all transactions with a given MCC, time period, date, and location for each merchant, and determining the average amount per business.

As noted, the mobile business category could be, for example, “restaurants,” or more particularly “food trucks.” Optionally, a further step could include gathering data from multiple food trucks to determine the average fraction of total spending in the business category for the average business in the business category for the given time of day, day of week, and location (essentially looking at data with a granularity that is finer than available by querying warehouse 2062 based on MCC).

In some instances (see item 1414 in FIG. 14), the at least one insight includes average spending per account for the mobile business for a given time of day, day of week, and location; and a further step includes calculating the average spending per account. For example, query data such as the table of FIG. 13 and calculate the average spend (optionally, for simplicity, assume each account is used only once at the mobile business during the day and time period of interest). Optionally, also provide the mobile business, for comparison purposes, average spending per account in the business category of the mobile business for an average business in the business category for the given time of day, day of week, and location. This can be done, for example, by querying data warehouse 2062 for all transactions with a given MCC, time, date, and location for each merchant, and determining the average transaction amount.

Optionally, a further step could include gathering data from multiple food trucks to determine the average spending per account in the business category for the average business in the business category for the given time of day, day of week, and location.

Any or all of the steps can be repeated as needed for additional mobile businesses.

In some instances, location also includes altitude determined by an altitude sensor such as atmospheric pressure transducer 841; e.g., a hand-pushed cart within a public space, mall, multi-story building or the like (e.g., entries in table of FIG. 12 also include altitude).

In an alternative embodiment, another exemplary method includes making browser-executable code available to a browser 897 of a mobile device associated with a mobile business 1001. This can be done, for example, by serving out HTML from a server associated with the environment 1007 and operated by the payment card network operator 2008. A further step includes obtaining, from the mobile business, data describing a varying location of the mobile business over a time period of interest, by client-server communication over a wireless network 1003 (mobile device is the client). The data also includes an identifying indicia of the mobile business. The varying location of the mobile business over the time period of interest is tracked by the browser-executable code interfacing with a global positioning system unit 899 of the mobile device associated with the mobile business. A further step includes querying a database of payment card transactions (see above discussion of step 1108) based on the identifying indicia of the mobile business to obtain payment card transaction data for a plurality of transactions at the mobile business during the time of interest. The payment card transaction data includes for each of the transactions, amount and time stamp. An even further step (see discussion of step 1110 above) includes assigning, to each of the transactions, a location, based on matching the time stamps of each of the transactions with a corresponding location in the data describing the varying location of the mobile business over the time period of interest, to obtain augmented transaction data. Yet a further step includes, as discussed above, sending an alert to the browser of the mobile device based on the augmented transaction data. The steps of the alternative embodiment can be repeated as desired for additional businesses, and the various optional steps of the first embodiment can also be included as appropriate in some implementations of the second embodiment.

One or more embodiments thus address challenges that arise in the context of correlating global positioning system data and ISO 8583 network transaction data or the like. In one or more embodiments, efficiencies are gained in the process by parallel processing real-time data from the truck owner within a Hadoop server environment using Impala, a SQL based language that is run in memory to process information faster. Thus, environment 1007 can be implemented, for example, by one or more physical servers 900, which may or may not host virtual servers, running one or more appropriate software programs as described herein. Application server 1005 can be implemented by the same or different physical and/or virtual servers as the other components.

The components shown in environment 1007 in FIG. 10 can be located, for example, at central facility 2009 of the payment card network operator 2008. Databases 1013, 1014 can be new databases and/or can be implemented by modifying one of the existing databases 2054, 2062, for example. Furthermore, databases can be combined or separated as appropriate. Databases include persistent storage and a database program and user interface. The user interface can be an API to another computer system that acts like a portal, or can be a GUI implemented by serving out hypertext markup language (HTML) from a server to a client's browser, for example.

### System and Article of Manufacture Details

Embodiments of the disclosure can employ hardware and/or hardware and software aspects. Software includes but is not limited to firmware, resident software, microcode, etc. Software might be employed, for example, in connection with one or more of a terminal 122, 124, 125, 126; a reader 132; a host, server, and/or processing center 140, 142, 144 (optionally with data warehouse 154) of a merchant, issuer, acquirer, processor, bank, agent, third party, or operator of a payment network 2008; a mobile device 800; analytical environment 1007; and the like. Firmware might be employed, for example, in connection with payment devices such as cards 102, 112, as well as reader 132.

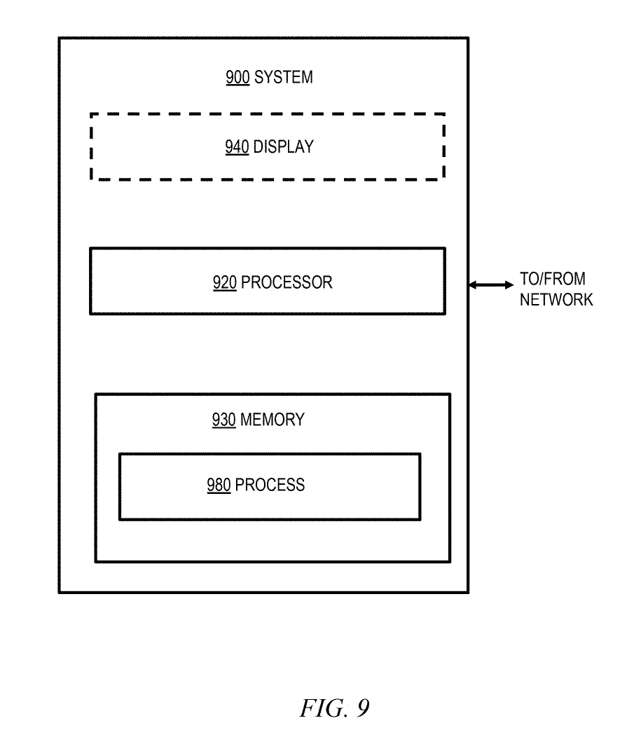

FIG. 9 is a block diagram of a system 900 that can implement part or all of one or more aspects or processes of the disclosure. As shown in FIG. 9, memory 930 configures the processor 920 (which could correspond, e.g., to processor portions 106, 116, 130; a processor of a terminal or a reader 132; processors of remote hosts in centers 140, 142, 144; processor 802; processors of hosts and/or servers implementing systems in FIG. 10 and their components; processors of hosts and/or servers of other parties described herein; and the like); to implement one or more aspects of the methods, steps, and functions disclosed herein (collectively, shown as process 980 in FIG. 9). Different method steps can be performed by different processors. The memory 930 could be distributed or local and the processor 920 could be distributed or singular. The memory 930 could be implemented as an electrical, magnetic or optical memory, or any combination of these or other types of storage devices (including memory portions as described above with respect to cards 102, 112). It should be noted that if distributed processors are employed, each distributed processor that makes up processor 920 generally contains its own addressable memory space. It should also be noted that some or all of computer system 900 can be incorporated into an application-specific integrated circuit (ASIC) or general-use integrated circuit. For example, one or more method steps could be implemented in hardware in an ASIC or field-programmable gate array (FPGA) rather than using firmware. Display 940 is representative of a variety of possible input/output devices (e.g., displays, printers, keyboards, mice, touch screens, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer implementing systems in FIG. 10 and their components; on processors of hosts and/or servers of other parties described herein; on processor(s) of mobile devices; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the disclosure, such as, for example, 124, 125, 126, 140, 142, 144, 2004, 2006, 2008, 2010; a computer implementing systems in FIG. 10 and their components; processors of hosts and/or servers of other parties described herein; processor(s) of mobile devices; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 900 as shown in FIG. 9) running a server program. It will be understood that such a physical server may or may not include a display, keyboard, or other input/output components. A “host” includes a physical data processing system (for example, system 900 as shown in FIG. 9) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. The method steps can, in any event, be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

One example of a user interface module to implement a UI is hypertext markup language (HTML) code served out by a server or the like, to a browser of a computing device of a user. The HTML is parsed by the browser on the user's computing device to create a graphical user interface (GUI).

Thus, aspects of the disclosure can be implemented, for example, by one or more appropriately programmed general purpose computers, such as, for example, servers, mobile devices, or personal computers, located at one or more of the entities in the figures, as well as within the payment network 2008. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, R, Structured Query Language (SQL), Hive, Hadoop, Impala and the like (an exemplary and non-limiting list), and can also make use of, for example, Extensible Markup Language (XML), known application programs such as relational database applications (e.g., IBM DB2® software available from International Business Machines Corporation, Armonk, N.Y., US; SAS® software available from SAS Institute, Inc., Cary, N.C., US), spreadsheets (e.g., MICROSOFT EXCEL® software available from Microsoft Corporation, Redmond, Wash., US), Netezza (IBM Netezza Data Warehouse Appliances available from International Business Machines Corporation, Armonk, N.Y., USA), Citrix® environment, and the like. The Apache Hadoop software library is a framework that allows for the distributed processing of large data sets across clusters of computers using simple programming models. Apache Hive is a data warehouse infrastructure built on top of Hadoop for providing data summarization, query, and analysis. Impala is an open source, native analytic database for Apache Hadoop. Graph databases rather than relational databases could be used in some instances. The computers can be programmed to implement the logic and/or data flow depicted in the figures. In some instances, messaging and the like may be in accordance with the International Organization for Standardization (ISO) Specification 8583 Financial transaction card originated messages Interchange message specifications and/or the ISO 20022 or UNIFI Standard for Financial Services Messaging, also incorporated herein by reference in its entirety for all purposes. In one or more embodiments, some messages may be in accordance with NACHA Automated Clearing House (ACH) rules and regulations.

Although illustrative embodiments of the disclosure have been described herein with reference to the accompanying drawings, it is to be understood that the disclosure is not limited to those precise embodiments, and that various other changes and modifications may be made by one skilled in the art without departing from the scope or spirit of the disclosure.

What is claimed is:

1. A method comprising:
making a mobile application available for download to a mobile device associated with a mobile business;
obtaining, from said mobile business, data describing a varying location of said mobile business over a time period of interest, by exposing an application programming interface to said mobile application over a wireless network, said data also including an identifying indicia of said mobile business, said varying location of said mobile business over said time period of interest having been tracked by said mobile application interfacing with a global positioning system unit of said mobile device associated with said mobile business;
querying a database of payment card transactions based on said identifying indicia of said mobile business to obtain payment card transaction data for a plurality of transactions at said mobile business during said time of interest, said payment card transaction data comprising, for each of said transactions, amount and time stamp;
assigning, to each of said transactions, a location, based on matching said time stamps of each of said transactions with a corresponding location in said data describing said varying location of said mobile business over said time period of interest, to obtain augmented transaction data; and
sending an alert to said mobile application based on said augmented transaction data.

2. The method of claim 1, further comprising affording a user of said mobile application an option to initiate targeted offers for said mobile business, based on said augmented transaction data.

3. The method of claim 2, further comprising obtaining a communication from said user of said mobile application to initiate said targeted offers.

4. The method of claim 3, further comprising, responsive to said communication from said user of said mobile application, initiating said targeted offers.

5. The method of claim 3, further comprising, responsive to said communication from said user of said mobile application, initiating a communication with a third party to provide said targeted offers.

6. The method of claim 1, further comprising providing said mobile business with at least one insight derived from said augmented transaction data.

7. The method of claim 6, wherein said at least one insight comprises performance by time of day, day of week, and location.

8. The method of claim 6, wherein:
said mobile business is associated with a business category; and
said at least one insight comprises a fraction of total spending in said business category for said mobile business for a given time of day, day of week, and location;
further comprising calculating said fraction.

9. The method of claim 8, further comprising providing said mobile business with an average fraction of total spending in said business category for an average business in said business category for said given time of day, day of week, and location.

10. The method of claim 9, wherein said mobile business comprises a food truck and said business category comprises restaurants.

11. The method of claim 9, wherein said mobile business comprises a food truck and said business category comprises food trucks, further comprising gathering data from multiple food trucks to determine said average fraction of total spending in said business category for said average business in said business category for said given time of day, day of week, and location.

12. The method of claim 6, wherein said at least one insight comprises average spending per account for said mobile business for a given time of day, day of week, and location;
further comprising calculating said average spending per account.

13. The method of claim 12, wherein said mobile business is associated with a business category, further comprising providing said mobile business with an average spending per account in said business category for an average business in said business category for said given time of day, day of week, and location.

14. The method of claim 13, wherein said mobile business comprises a food truck and said business category comprises restaurants.

15. The method of claim 13, wherein said mobile business comprises a food truck and said business category comprises food trucks, further comprising gathering data from multiple food trucks to determine said average spending per account in said business category for said average business in said business category for said given time of day, day of week, and location.

16. The method of claim 1, further comprising repeating said making available, obtaining, querying, assigning, and sending steps for a plurality of additional mobile businesses.

17. A non-transitory computer readable medium comprising computer executable instructions which when executed by a computer cause the computer to perform the method of:
making a mobile application available for download to a mobile device associated with a mobile business;
obtaining, from said mobile business, data describing a varying location of said mobile business over a time period of interest, by exposing an application programming interface to said mobile application over a wireless network, said data also including an identifying indicia of said mobile business, said varying location of said mobile business over said time period of interest having been tracked by said mobile application interfacing with a global positioning system unit of said mobile device associated with said mobile business;
querying a database of payment card transactions based on said identifying indicia of said mobile business to obtain payment card transaction data for a plurality of transactions at said mobile business during said time of interest, said payment card transaction data comprising, for each of said transactions, amount and time stamp;
assigning, to each of said transactions, a location, based on matching said time stamps of each of said transactions with a corresponding location in said data describing said varying location of said mobile business over said time period of interest, to obtain augmented transaction data; and
sending an alert to said mobile application based on said augmented transaction data.

18. The non-transitory computer readable medium of claim 17, wherein said instructions further cause the computer to perform the additional method step of affording a user of said mobile application an option to initiate targeted offers for said mobile business, based on said augmented transaction data.

19. An apparatus comprising:
a memory;
at least one processor, coupled to the memory; and
a non-transitory computer readable medium comprising computer executable instructions which when loaded into the memory configure the at least one processor to:
make a mobile application available for download to a mobile device associated with a mobile business;
obtain, from said mobile business, data describing a varying location of said mobile business over a time period of interest, by exposing an application programming interface to said mobile application over a wireless network, said data also including an identifying indicia of said mobile business, said varying location of said mobile business over said time period of interest having been tracked by said mobile application interfacing with a global positioning system unit of said mobile device associated with said mobile business;
query a database of payment card transactions based on said identifying indicia of said mobile business to obtain payment card transaction data for a plurality of transactions at said mobile business during said time of interest, said payment card transaction data comprising, for each of said transactions, amount and time stamp;
assign, to each of said transactions, a location, based on matching said time stamps of each of said transactions with a corresponding location in said data describing said varying location of said mobile business over said time period of interest, to obtain augmented transaction data; and
send an alert to said mobile application based on said augmented transaction data.

20. The apparatus of claim 19, wherein said instructions, when loaded into the memory, further configure the at least one processor to afford a user of said mobile application an option to initiate targeted offers for said mobile business, based on said augmented transaction data.

21. A method comprising:
making browser-executable code available to a browser of a mobile device associated with a mobile business;
obtaining, from said mobile business, data describing a varying location of said mobile business over a time period of interest, by client-server communication over a wireless network, said data also including an identifying indicia of said mobile business, said varying location of said mobile business over said time period of interest having been tracked by said browser-executable code interfacing with a global positioning system unit of said mobile device associated with said mobile business;
querying a database of payment card transactions based on said identifying indicia of said mobile business to obtain payment card transaction data for a plurality of transactions at said mobile business during said time of interest, said payment card transaction data comprising, for each of said transactions, amount and time stamp;
assigning, to each of said transactions, a location, based on matching said time stamps of each of said transactions with a corresponding location in said data describing said varying location of said mobile business over said time period of interest, to obtain augmented transaction data; and
sending an alert to said browser of said mobile device based on said augmented transaction data.
